(19) United States
(12) Patent Application Publication
(10) Pub. No.: US 2007/0232245 A1
(43) Pub. Date: Oct. 4, 2007

(54) Wireless Audio Signal Transmitter Device Capable Of Automatic Channel Locking

(76) Inventor: Ching-Wei Cheng, Hsichih City (TW)

Correspondence Address: LIN & ASSOCIATES INTELLECTUAL PROPERTY, P.O. BOX 2339, SARATOGA, CA, 95070-0339, US

(21) Appl. No.: 11/557,969

(22) Filed: Nov. 9, 2006

(30) Foreign Application Priority Data
Mar. 9, 2006 (TW) 095107935

(51) Int. Cl. H04B 1/02

(52) U.S. Cl. 455/93; 455/66.1; 455/63.3; 381/79

(57) ABSTRACT

A wireless audio signal transmitter device capable of automatically and dynamically locking a working frequency for a wireless channel thereof with respect to a wireless audio playing device and a method therefore are disclosed. In locking a wireless channel associated with a working frequency, the wireless audio signal transmitter device automatically and dynamically transmits a sequence of at least a wireless audio signal to the wireless audio playing device. Upon a specific one of the sequence of at least a wireless audio signal having a communication frequency matching with a working frequency of the wireless audio playing device, a sound is played by the wireless audio playing device and received by the wireless audio signal transmitter device. Then, the wireless audio signal transmitter device locks its wireless channel based on the knowledge of the working frequency of the wireless audio playing device.

### BACKGROUND OF THE INVENTION

1. Field of the Invention

The present invention relates to a wireless audio signal transmitter device. Particularly, the present invention relates to a wireless audio signal transmitter device capable of automatic channel locking.

2. The Prior Arts

In traditional single channel wireless microphone transmitter and wireless speaker systems, an oscillation frequency emitted from quartz therein is generally used as a working frequency, i.e. the systems are each locked to the working frequency when operating so that the receiver system can receive a signal from the transmitter through a channel associated with the working frequency. Although such system is easy to be operated, a signal interference can be caused due to other signal source(s), when multiple such systems are operated concurrently, or a signal from the same system, which cannot be overcome by switching to another channel since the signal transmitting and receiving operations are both conducted at the same working frequency and this working frequency cannot be changed freely.

Although there have been some wireless signal receiving products with the function of automatic channel locking set forth, a multiple channel system is generally provided in circuits of the transmitting and receiving systems so that when a multiple of pairs of the transmitting and receiving systems are operated, the channels used therein can be conveniently set or selected to ones in a manner that the channels associated with the concurrently used multiple transmitting and receiving systems do not interfere with one another. However, each of the channels of the multiple pairs of the wireless microphone and wireless speaker systems have to be set in before the systems operate, which can become an annoyance for a user of the wireless microphone system who likes to use his/her own microphone or has to frequently sing or make a speech at different places.

To overcome this channel adjusting issue, various kinds of automatic channel adjustment mechanisms have been used. Although they are appeared to be effective, too many limitations are posed when being used, inhibiting growth of use thereof. For example, to let the channel used in each of the multiple pairs of wireless microphone and speaker known to the other pairs, various kinds of communications modules, e.g. infrared receiving/transmitting modules, have to be installed in the multiple wireless microphones and speakers to transmit the information of the channels thereof and further make negotiation of the usable channels possible. However, it is impossible to request all the manufacturers to install the communications modules in all the wireless microphone and speaker products all over the world and provide the products with the ability to automatic channel adjusting. The wireless microphone can be at most additionally provided with a particular module to achieve the same automatic channel locking function.

### SUMMARY OF THE INVENTION

To overcome the problem encountered in the prior art, it is an object of the present invention to provide a wireless audio signal transmitter device, which can automatically and dynamically locking a working frequency for a wireless channel thereof with respect to a wireless audio playing device, so that the wireless audio signal transmitter device can request the wireless audio playing device to play a sound according thereto through the wireless channel.

In accordance with the present invention, the wireless audio signal transmitter device capable of automatically and dynamically locking a working frequency for a wireless channel thereof with respect to a wireless audio playing device comprises a wireless transmitting module transmitting a sequence of at least a wireless audio signal from a plurality of wireless audio signals for test one by one, each of the plurality of wireless audio signals for test corresponding to a respective one of a plurality of predetermined communications frequencies one by one, an audio receiving module receiving at least a sound transmitted from the wireless audio playing device, and a channel locking module controlling the wireless transmitting module to transmit the sequence of at least a wireless audio signal from the plurality of wireless audio signals for test to the wireless audio playing device until the audio receiving module receives a sound in response to a specific one of the sequence of at least a wireless audio signal from the plurality of wireless audio signals for test from the wireless audio playing device and locking the working frequency of the wireless channel at a frequency associated with the specific wireless audio signal for test, so that the wireless audio playing device is allowed to play a sound according to a wireless audio signal from the wireless audio signal transmitter device through the wireless channel.

It is another object of the present invention to provide a method for automatically and dynamically locking a wireless audio signal transmitter device at a working frequency for a wireless channel thereof with respect to a wireless audio playing device, so that the wireless audio signal transmitter device can request the wireless audio playing device to play a sound according thereto through the wireless channel.

In accordance with the present invention, the method for automatically and dynamically locking a wireless audio signal transmitter device at a working frequency for a wireless channel thereof with respect to a wireless audio playing device comprises the steps of transmitting a sequence of audio signals from a plurality of wireless audio signals for test, each of the plurality of wireless audio signals for test corresponding to a respective one of a plurality of predetermined communications frequencies one by one, receiving a sound transmitted from the wireless audio playing device in response to a specific one of the sequence of at least a wireless audio signal from the plurality of wireless audio signals for test from the wireless audio playing device, and locking the working frequency of the wireless channel at a specific frequency associated with the specific wireless audio signals, so that the wireless audio playing device is allowed to play a sound according to a wireless audio signal from the wireless audio signal transmitter device.

Other objects, features and advantages of the present invention will be apparent to those skilled in the art after the description below with reference to the annexed drawings are read.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a schematic diagram of implementation of a wireless audio signal transmitter device capable of automatic channel locking which is communicated with a wireless audio playing device.

### DETAILED DESCRIPTION OF THE PREFERRED EMBODIMENT

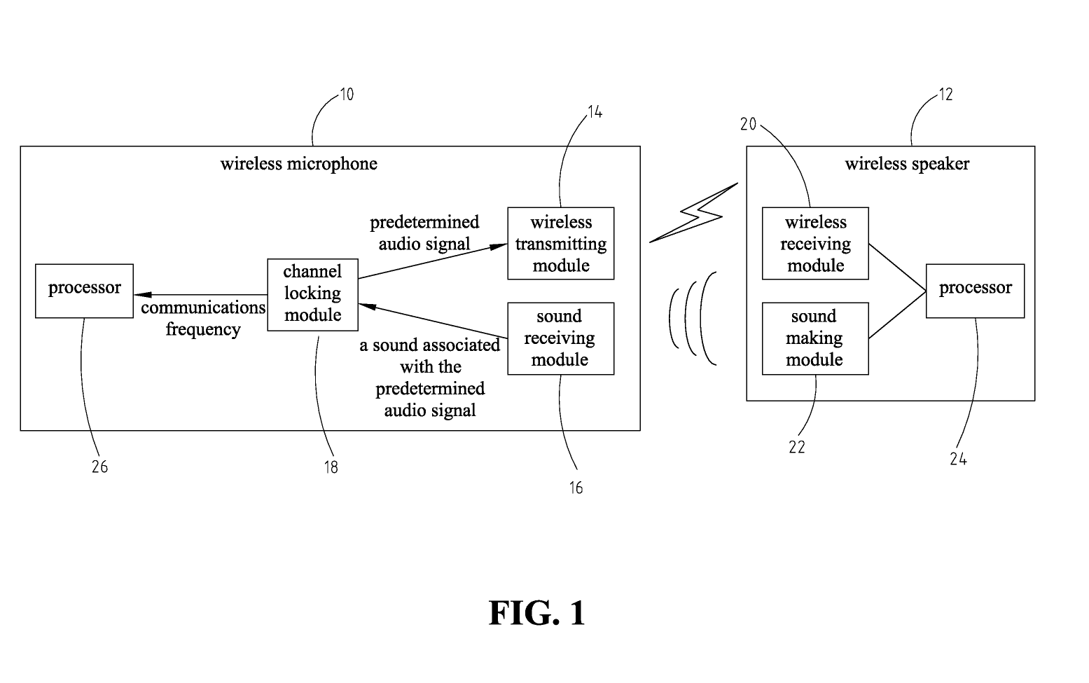

Referring to FIG. 1, a schematic diagram of implementation of a wireless audio signal transmitter device capable of automatic channel locking which is communicated with a wireless audio playing device, according to the present invention is depicted therein. As shown, the wireless audio signal transmitter device 10, which is herein exemplified by a wireless microphone, comprises a wireless transmitting module 14, an audio receiving module 16 and a channel locking module 18. In the wireless audio signal transmitter device 10, a processor 26 is also provided for processing audio signals and transmitting and the like. The wireless audio playing device (e.g. a wireless speaker, exemplified in the description) 12 comprises a wireless signal receiving module 20, a sound making module 22 and a processor 24.

When selecting a wireless channel so that communications with a wireless speaker may be possible, the wireless transmitting module 14 transmits under control of the processor 26 a sequence of at least a wireless audio signal from a plurality of wireless audio signals for test one by one, wherein each of the plurality of wireless audio signals for test corresponding to one of a plurality of predetermined communications frequencies. After the selection of the wireless channel is finished, i.e. when the wireless microphone is normally operated, the wireless transmitting module 14 can also transmits a wireless audio signal comprising one frequency modulated and amplitude modulated to the wireless speaker 10.

The audio receiving module 16 receives, when the selection of the wireless channel is performed, at least a sound transmitted from the wireless speaker 12, which will be explained in more detail below.

The channel locking module 18 controls, when the selection of the wireless channel is performed, the wireless transmitting module 14 to transmit a sequence of at least a wireless audio signal from the plurality of wireless audio signals for test to the wireless speaker 12 until the audio receiving module 16 receives a sound in response to a specific one of the sequence of at least a wireless audio signal from the plurality of wireless audio signals for test from the wireless speaker 12 and locking the working frequency of the wireless channel at a frequency associated with the specific wireless audio signal for test, so that the wireless speaker 12 is allowed to play a sound according to a wireless audio signal from the wireless microphone 10 through the wireless channel.

In principle, all communications frequencies of the plurality of wireless audio signals transmitted to the wireless speaker 12 are fallen within a specific frequency range. The plurality of wireless audio signals for test are transmitted to the wireless speaker 12 in a one-by-one manner until the specific one of the sequence of at least a wireless audio signal from the plurality of wireless audio signals for test from the wireless microphone 12 is found when the audio receiving module 16 receives a sound from the wireless speaker 12. At this time, it can be known that the wireless speaker 12 has a wireless channel having a working frequency identical to that of the wireless microphone 10. Meanwhile, the transmission process of the plurality of wireless audio signals for test is stopped and this working frequency is informed to the processor 26 by the channel locking module 18 and thus locked.

At the side of the wireless speaker 12, when the communications frequency of a wireless audio signal for test among the plurality of wireless audio signal is identical to the working frequency of the wireless speaker 12, the wireless receiving module 20 can receive the wireless audio signal for test. Then, the sound making module 20 plays a sound under control of the processor 24 thereof. Thus, the sound receiving module 16 can receive the sound from the wireless speaker 12 at the time when the wireless audio signal for test among the plurality of wireless audio signal transmitted is identical to the working frequency of the wireless speaker 12.

Since this process of selection of the wireless channel is performed automatically and dynamically, the wireless audio signal transmitter device is called a device capable of automatically and dynamically locking a working frequency for a wireless channel thereof with respect to a wireless audio playing device.

In the above, the sequence of at least a wireless audio signal from the plurality of wireless audio signals for test is transmitted in an order selected from the group consisting of from high to low, low to high and alternation.

In the above, the sound received by the wireless microphone 10 when the wireless audio signal for test has the communications frequency identical to the working frequency of the wireless speaker 12, is selected from the group consisting of a single tone, a sound having a plurality of frequencies, and consecutive tones.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A wireless audio signal transmitter device capable of automatically and dynamically locking a working frequency for a wireless channel thereof with respect to a wireless audio playing device, comprising:
a wireless transmitting module transmitting a sequence of at least a wireless audio signal from a plurality of wireless audio signals for test one by one, each of the plurality of wireless audio signals for test corresponding to a respective one of a plurality of predetermined communications frequencies one by one;
an audio receiving module receiving at least a sound transmitted from the wireless audio playing device; and
a channel locking module controlling the wireless transmitting module to transmit the sequence of at least a wireless audio signal from the plurality of wireless audio signals for test to the wireless audio playing device until the audio receiving module receives a sound in response to a specific one of the sequence of at least a wireless audio signal from the plurality of wireless audio signals for test from the wireless audio playing device and locking the working frequency of the wireless channel at a frequency associated with the specific wireless audio signal for test, so that the wireless audio playing device is allowed to play a sound according to a wireless audio signal from the wireless audio signal transmitter device through the wireless channel.

2. The wireless audio signal transmitter device as claimed in claim 1, wherein the channel locking module controls the wireless audio signal transmitter module to transmit the sequence of at least a wireless audio signal from the plurality of wireless audio signals for test in an order selected from the group consisting of from high to low, low to high and alternation.

3. The wireless audio signal transmitter device as claimed in claim 1, wherein the sound in response to the sequence of wireless audio signal from the plurality of wireless audio signals for test from the wireless audio playing device is selected from the group consisting of a single tone, a sound having a plurality of frequencies, and consecutive tones.

4. The wireless audio signal transmitter device as claimed in claim 1, wherein the each of the plurality of wireless audio signals transmitted from the wireless audio signal transmitter module is one of a frequency modulated (FM) signal and an (AM) amplitude modulated signal.

5. A method for automatically and dynamically locking a wireless audio signal transmitter device at a working frequency for a wireless channel thereof with respect to a wireless audio playing device, comprising: transmitting a sequence of audio signals from a plurality of wireless audio signals for test, each of the plurality of wireless audio signals for test corresponding to a respective one of a plurality of predetermined communications frequencies one by one;
receiving a sound transmitted from the wireless audio playing device in response to a specific one of the sequence of at least a wireless audio signal from the plurality of wireless audio signals for test from the wireless audio playing device; and
locking the working frequency of the wireless channel at a specific frequency associated with the specific wireless audio signals, so that the wireless audio playing device is allowed to play a sound according to a wireless audio signal from the wireless audio signal transmitter device.

6. The method as claimed in claim 5, wherein the step of transmitting comprises a step of transmitting the sequence of at least a wireless audio signal from the plurality of wireless audio signals for test in an order selected from the group consisting of from high to low, low to high and alternation.

7. The method as claimed in claim 5, wherein the sound is selected from the group consisting of a single tone, a sound having a plurality of frequencies, and consecutive tones.

8. The method as claimed in claim 5, wherein the each of the plurality of wireless audio signals transmitted from the wireless audio signal transmitter module is one of a frequency modulated (FM) signal and an (AM) amplitude modulated signal.
